(19) United States
(12) Patent Application Publication
(10) Pub. No.: US 2013/0028657 A1
(43) Pub. Date: Jan. 31, 2013

(54) METAL FASTENING FITTING

(71) Applicant: Okura Kenho, Namerikawa (JP)

(72) Inventor: Okura Kenho, Namerikawa (JP)

(21) Appl. No.: 13/634,552

(22) PCT Filed: Mar. 30, 2011
(86) PCT No.: PCT/JP2011/058000

§ 371 Date: Sep. 13, 2012

(30) Foreign Application Priority Data
Apr. 1, 2010 (JP) 2010-085426

(51) Int. Cl. E04B 1/58; F16B 7/00

(52) U.S. Cl. 403/188

(57) ABSTRACT

Provided is a metal fastening fitting whereby a support member (51), such as a pillar, and a connecting member (61), such as a beam, are fastened to one another in a T-shaped manner. The metal fastening fitting is such that a front surface section (11) which is to be fixed to a side of the support member (51) is spatially separated from rear edge sections (31) which are to be inserted into slits (62) in the connecting member (61) and are to be fixed by drift pins (47) or the like, and the front surface section (11) and the rear edge sections (31) are integrated together only by a plurality of ramiform sections (23, 25, 27).

### TECHNICAL FIELD

The present invention relates to a metal fastening fitting used in fastening two members, such as, a beam and a pillar, in a T-shaped manner in various wooden structures.

### BACKGROUND ART

The wooden frame construction method, which is fairly common as a method for construction of residential housing or the like, erects the framework of a building by combing members including a base, pillars and beams. In this method of construction, the members need to be fastened robustly with each other in order to ensure the strength of the framework, and measures, such as the mortise and tenon joint formed at the end surfaces of the members, have been taken through the ages. In recent years, however, usage of various metal fastening fittings is becoming more common, accompanied by the introduction of a precut technique and so on.

An exemplary shape of a metal fastening fitting used in fastening two members such as a beam and a pillar in a T-shaped manner is shown in FIG. 12. This metal fastening fitting has a U-shape, formed by bending a steel plate at two positions, and comprises a front surface plate positioned in the middle and side plates projecting from both left and right sides thereof. On the front surface plate, columnar two projections are formed in vertically adjoining manner. The interior of the projection is designed to be empty in order to accommodate the head of a bolt, and a front hole for insertion of a bolt is formed at the center of the projection. In addition, the two side plates have the same shape each of which has a V-shaped pin groove on its upper edge and two pinholes beneath and vertically inline with the pin groove.

In order to attach the metal fastening fitting, on a side surface of the pillar, receiving holes, drilled holes and counterbores are machined in advance. The receiving hole is for fitting the projection of the metal fastening fitting therein, the drilled hole is for inserting the bolt for fixing the metal fastening fitting, and the counterbore is for receiving a nut screwed onto the bolt. On the execution of construction work, the projection of the metal fastening fitting is fit in the receiving hole of the pillar, and then a bolt is inserted into the projection as it passes through the space between two side plates so that the end of the bolt reaches to the counterbore through the drilled hole. When a washer is put around the end of the bolt and then the nut is screwed tightly, the metal fastening fitting is brought into an intimate contact with the side surface of the pillar.

On an end portion of the beam, an offset portion to receive the front surface plate and double slits into which the side plates are inserted are machined. Further, on the side surface of the beam, side holes for driving a drift pin therethrough are machined in advance. Into the topmost side hole, the drift pin is driven in advance. Upon execution of construction work, after the metal fastening fitting is attached to the side surface of the pillar, the beam is lifted up and moved to the position right above the metal fastening fitting. Then, when the beam is gradually moved down, the side plates of the metal fastening fitting are inserted into the slits accordingly, and eventually the drift pin already driven in is received by the pin grooves, thus completing temporary placing of the beam. After that, when drift pins are driven to the remainder of the side holes, the pillar and the beam are fastened via the metal fastening fitting. Instead of the drift pin, a bolt may be used.

Examples of techniques related to the present invention are indicated in Patent Literature 1 and other literatures listed. Patent Literature 1 discloses a metal joint having certain strength while achieving its downsizing. Further, Non-Patent Literatures (Publications of Japanese Design Registrations) disclose a construction member fixing fitting in which a portion of the side surface thereof is cut off for the purpose of weight reduction and aesthetic refinement respectively.

### PRIOR ART LITERATURE

Patent Literature 1: Unexamined Japanese Patent Application Laid-open Publication No. 2007-278027
Non-Patent Literature 1: Japanese Registered Design Publication No. 1212158
Non-Patent Literature 2: Japanese Registered Design Publication No. 1218754

### DISCLOSURE OF INVENTION

### Problems to be Solved by the Invention

When an excessive load is applied onto the fastening portion as shown in FIG. 12, a crack is caused around the drift pin in the lumber first, and often it gradually grows to destroy the beam. Therefore, in some cases, merely improving the strength of the metal fastening fitting alone might not result in improved strength of the fastening portion. Moreover, lumbers have individual differences in strength due to various factors, such as, presence or absence of knots and moisture content, and stages of deterioration that lead to such destruction is irregular as well. Then, in order to ensure the safety and stability of the fastening portion, it is preferable to design the metal fastening fitting to deform intentionally and absorb energy, so that crack generation and propagation within the member are minimized.

It is preferable that the metal fastening fitting as shown in FIG. 12 is supplied as inexpensively as possible in order to reduce the economic burden to consumers. Further, the metal fastening fittings are fairly common, and arrangement of bolts and drift pins for attachment is stylized. Therefore, also regarding a replacement metal fastening fitting, it is preferable not to change the position of pinholes and pin grooves in order to ensure the interchangeability with conventional fastening fittings.

The present invention is developed in view of the foregoing circumstances, and an object of the present invention is to provide a metal fastening fitting that can delay the destruction of the members, such as beams, as much as possible when an excessive load is applied thereunto, and provide superior performance in safety and stability.

### Means for Solving the Problems

In order to address the above-described problem, the invention recited in Claim 1 is a metal fastening fitting for fastening an end surface of a connecting member to a side surface of a support member in a T-shaped manner, comprising: a front surface section being in contact with the side surface of the support member and fixed to the support member, by a bolt, a nail or the like; and a rear edge section inserted into a slit machined on an end portion of the connecting member and fixed to a connecting member by a bar such as a drift pin, wherein a front hole for insertion of a bolt, a nail or the like is provided on the front surface section, and a pinhole for insertion of the drift pin, the nail or the like or a pin groove for receiving the drift pin or the like is provided on the rear edge section, and the front surface section and the rear edge section are joined with each other, via a plurality of ramiform sections.

The metal fastening fitting according to the present invention is used to fasten bar-shaped lumber in a T-shaped manner in various wooden structures, and similarly to the conventional techniques, comprises a front surface section being in contact with a side surface of a support member, such as a pillar, and a rear edge section inserted into a slit of a connecting member, such as a beam. The front surface section is a portion that comes in surface-contact with the side surface of the support member to be fixed to the support member by a bolt, a nail or a small screw or the like, and does not essentially require any projection for positioning. However, the front hole is always provided in order to allow insertion of a bolt, a nail or a small screw or the like.

The shape of the metal fastening fitting may be, in addition to a U-shape in which a pair of rear edge sections project from both side portions of the front surface section, a T-shape in which one rear edge section projects from the center of the front surface section. In the U-shaped metal fastening fitting, the rear edge section exists in left and right two positions respectively, in which the left and right rear edge sections have the same shape. Therefore, the description herein depicts either of the left or right portions to describe the shape of the rear edge section and/or the like. As the T-shaped fitting has only a single rear edge section, consequently only a single slit machined on the end portion of the connecting member is necessary.

The rear edge section is a portion fixed to the connecting member via a bar such as a drift pin and a bolt, and the whole of the rear edge section is inserted into a slit machined on the connecting member. Further, on the rear edge section, the pinhole for insertion of the drift pin and a pin groove curved in a semicircle shape to receive the drift pin or the like are formed. However, the pin groove is not required, and might not be formed depending on the use. All of the pinholes and the pin grooves are formed on the rear edge section, and are never formed on another portion. In the present invention, the front surface section and the rear edge section are not simply connected with one another, but the front surface section and the rear edge section are spatially separated from each other, and coupled with one another via the ramiform sections.

The ramiform section serves to couple the front surface section with the rear edge section, and is a portion that actually projects to be in a ramiform shape with the front surface section providing support. The ramiform shape refers to a shape having a finite width (in a direction perpendicular to its extending direction in which it extends), and being a peninsular shape locally projecting from the outer edge of the front surface section. Further, typically two or more ramiform sections are always used, however, the shapes of each of ramiform sections do not need to be uniform, and the shapes may be determined arbitrarily. It is not necessary that the ramiform section is a basic strap shape, and it is possible to provide a fillet in an end portion thereof to ease concentration of stress. In addition, the minimal width of the ramiform section is determined each time depending on the shape of the metal fastening fitting and conditions of loads.

It is possible that the front surface section has a basic planar shape. However, in order to secure balance with the ramiform section, the shape may be U-shaped or T-shaped. In this case, the front surface section comprises a front surface plate having a plate-like shape and being in surface-contact with the support member, and a front edge plate projecting at a right angle against the front surface plate to be connected to the ramiform sections.

In this way, by integrating the front surface section and the rear edge section by a plurality of ramiform sections, when an excessive load is applied onto a drift pin or the like, the ramiform sections undergo plastic deformation in such a manner as to be depressed in the vicinity of the support of the ramiform sections being as a fulcrum. This absorbs energy and lightens the load applied onto the members thereby minimizing crack generation and propagation within the member.

The invention recited in Claim 2 specifies the shape of the rear edge section. The rear edge section is an islet portion provided on an end of each of ramiform sections, wherein each of the islet portions comprises the pinhole or the pin groove. The end of a ramiform section means a position most distant from the front surface section in the ramiform section. Further, the islet portions are portions to form a pinhole or a pin groove, and normally have the shape in which the end portion of the ramiform section is extended into a disc-like shape. However, for convenience, a portion that is merely extended from a strip-shaped ramiform section may be treated as islet portions in some cases. By providing the islet portions in this way, it becomes possible to freely adjust the width of the ramiform sections and facilitates plastic deformation upon application of an excessive load. Further, the ramiform sections and islet portions are provided in a one-to-one relationship.

The invention recited in Claim 3 specifies the shape of the islet portions, and all the islet portions are coupled with each other via a connection plate. Although every two vertically adjoining islet portions are separated from one another, it is possible, as in this invention, to integrate all the islet portions by providing a connection plate connecting adjoining islet portions. The connection plate is included in the rear edge section. Further, in order to ensure the strength of the rear edge section, a ramiform section may be provided that directly connects the connection plate and the front surface section. By providing the connection plate in this way, the loads applied onto individual ramiform sections are equalized, so that the whole of the ramiform sections undergo plastic deformation in a well-balanced manner.

The invention recited in Claim 4 specifies the shape of the rear edge section, in which the rear edge section is a vertically extending strip-shaped vertical plate, and a pinhole and a pin groove are provided in the vertical plate. The vertical plate is a single, vertically extending rectangular plate that has a pinhole, and on either or both of the upper and lower surfaces may have a pin groove formed where necessary. By using the vertical plate in this manner, the pinhole and the pin groove may be formed without depending on an arrangement of the ramiform sections, thus allowing for more flexible design shapes of metal fastening fittings.

The invention recited in Claim 5 specifies a shape of the ramiform section in which the ramiform section is inclined upwardly from the front portion to the rear edge section. There is no problem with providing the ramiform sections to project horizontally from the front surface section. However, by using the upward inclination of the ramiform sections, the ramiform section is more susceptible to plastic deformation as a bending moment may occur in the ramiform sections when a horizontal load is applied onto the rear edge section. Moreover, when a load is applied downwardly onto the rear edge section, the ramiform sections undergo plastic deformation in a rotational manner near the support of the ramiform sections, that is, a boundary with the front surface section. Furthermore, an area for the plastic deformation to naturally occur can be extended, so that a greater toughness is more likely to be achieved. Here, upward inclination means that both upper and lower surfaces of a ramiform section are angled toward an upward direction.

The invention recited in Claim 6 specifies the shape of the ramiform section, in which the center portions of the ramiform sections are configured to project either upwardly or downwardly, to have an L shape or an arcuate shape. There is no problem with providing the ramiform sections to project horizontally from the front surface section. However, by using such ramiform sections, deformation in this manner, bending moment is generated on the ramiform section when a horizontal load is applied onto the rear edge section, so that the plastic deformation occurs more readily. In this embodiment, it is assumed that the metal fastening fitting is used by being placed upside down.

### Effects of the Invention

As in the invention recited in Claim 1, for a metal fastening fitting that fastens two portions in a T-shape, spatial separation of a front surface section fixed to the side surface of the support member from a rear edge section inserted into the slit of the connecting member and fixed by a drift pin or the like, and coupling of the front surface section and the rear edge section solely by a plurality of ramiform sections, cause greater stress in the ramiform section when an excessive load is applied between the support member and the connecting member. As a result, the ramiform sections undergo plastic deformation by absorbing the stress prior to crack formation of the member, thus maximizing a member destruction delay. Further, by adjusting the shape and number of the ramiform sections, it is possible to optimize ideal plastic deformation for any condition to enhance general versatility. The present invention can be fabricated by conventional manufacturing processes except for a change in the cutting shape of a steel plate. Therefore, cost of the product can be reduced.

As in the invention recited in Claim 2, by providing an islet portion for the end of each of ramiform sections and further providing, a pinhole or a pin groove for the each of islet portions, the width of the ramiform section can be freely adjusted so that the plastic deformation can readily occur when an excessive load is applied. Further, as in the invention recited in Claim 3, by integrating all the islet portions by a connection plate, energy can be absorbed also by plastic deformation of the connection plate, which maximizes the promotion of member destruction delay. In addition to this, since all ramiform sections are arrayed on a same plane without level differences, when the steel plate is bent in the manufacturing step of the metal fastening fitting, a superior quality can be achieved.

As in the invention recited in Claim 4, by forming the rear edge section into a strip-shaped vertical plate, it becomes possible to easily form the pinhole and the pin groove without depending on the arrangement of the ramiform sections, to improve general versatility. Therefore, the manufacturing cost can be reduced and, in addition, interchangeability with conventional metal fastening fittings can be easily ensured, enhancing convenience as well.

As in the invention recited in Claim 5, by configuring the ramiform sections to be inclined upwardly, a bending moment is generated on the ramiform sections when a horizontal load is applied onto the rear edge section, so that the plastic deformation of the ramiform section readily occurs. Therefore, energy can be efficiently absorbed and the destruction of member can be delayed as much as possible. Further, when an excessive load is applied, the ramiform sections undergo plastic deformation in the manner of rotating within the vicinity of the support of the ramiform sections, a support point. In this process, since the distance between the front surface section and the rear edge section does not change significantly until the ramiform sections are angled to some extent downward. Therefore, the plastic deformation progresses naturally and toughness is more likely to be exercised.

As in the invention recited in Claim 6, by configuring the ramiform sections to have an inclined L shape or an arcuate shape and project either upwardly or downwardly, bending moment is generated on the ramiform sections when a horizontal load is applied onto the rear edge section, so that the ramiform sections undergo plastic deformation in the manner of being expanded. Therefore, the energy can be absorbed efficiently, and the destruction of the joint portions can be refrained as much as possible. Further, until the ramiform sections are angled to some extent downward, the distance between the front surface section and the rear edge section does not change significantly. Therefore, plastic deformation may progress naturally thus enhancing toughness.

### BRIEF DESCRIPTION OF DRAWINGS

FIG. 1 is a perspective view showing an exemplary shape of a metal fastening fitting according to the present invention and a use state;

FIG. 2 is a diagram showing the detail of the metal fastening fitting shown in FIG. 1, in which (a) is a perspective view, (b) is a side view, (c) is an enlarged view of the upper portion of the side surface, and (d) is an enlarged view of a mid portion of a side surface;

FIG. 3 is a diagram showing a metal fastening fitting without using a connection plate, in which (a) is a perspective view, and (b) is a side view and (c) is an enlarged view of the upper portion thereof, and (d) is an enlarged view of the mid portion of the side surface;

FIG. 4 is a diagram showing the details of a metal fastening fitting in which the number of ramiform sections is increased, in which (a) is a perspective view, (b) is a side view, (c) is an enlarged view of the upper portion of the side surface, and (d) is an enlarged view of the mid portion of the side surface;

FIG. 5 is a diagram showing a metal fastening fitting in which a vertical plate is used as a rear edge section, in which (a) is a perspective view, and (b) is a side view;

FIG. 6 is a perspective view showing another exemplary shape of the metal fastening fitting, in which (a) shows another exemplary shape 1 in which the front surface section has a plate-like shape, and (b) shows another exemplary shape 2 in which only one rear edge section is provided;

FIG. 7 is a side view showing another exemplary shape of the metal fastening fitting, and the shown structures are based on the embodiment shown in FIG. 5, in which (a) is another exemplary shape 3, (b) shows another exemplary shape 4 and (c) shows another exemplary shape 5;

FIG. 8 is a side view showing a method of testing for evaluating the strength of metal fastening fitting;

FIG. 9 is a diagram showing a method of evaluating a result of the test in FIG. 8, in which (a) shows a relationship between the displacement and the load, and (b) shows a method of computing a short-term capacity of proof stress;

FIG. 10 is a diagram showing a result of a test obtained by a method shown in FIG. 8, in which (a) shows a result of a test of a metal fastening fitting according to the present invention, and (b) shows a result of a test of a conventional metal fastening fitting;

FIG. 11 is a side view showing a state of plastic deformation caused when an excessive load is applied onto the metal fastening fitting shown in FIG. 2, in which (a) shows the metal fastening fitting before deformation, (b) shows the metal fastening fitting after deformation, (c) shows ramiform sections of the metal fastening fitting before deformation, and (d) shows the ramiform section of the metal fastening fitting after deformation; and

FIG. 12 is a diagram showing an exemplary shape of a common metal fastening fitting, in which (a) is a perspective view showing an exemplary shape of the metal fastening fitting and a state in which it is in use, (b) is a perspective view showing an exemplary shape of the metal fastening fitting viewed from the back, and (c) is a cross-sectional view showing an exemplary shape of the metal fastening fitting.

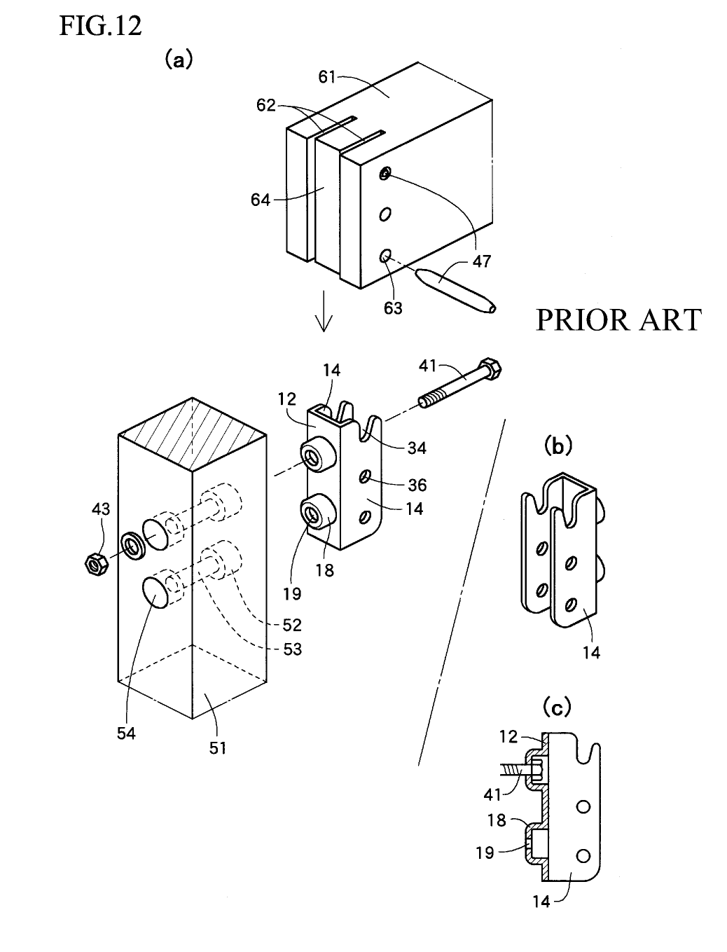

### MODE FOR CARRYING OUT THE INVENTION

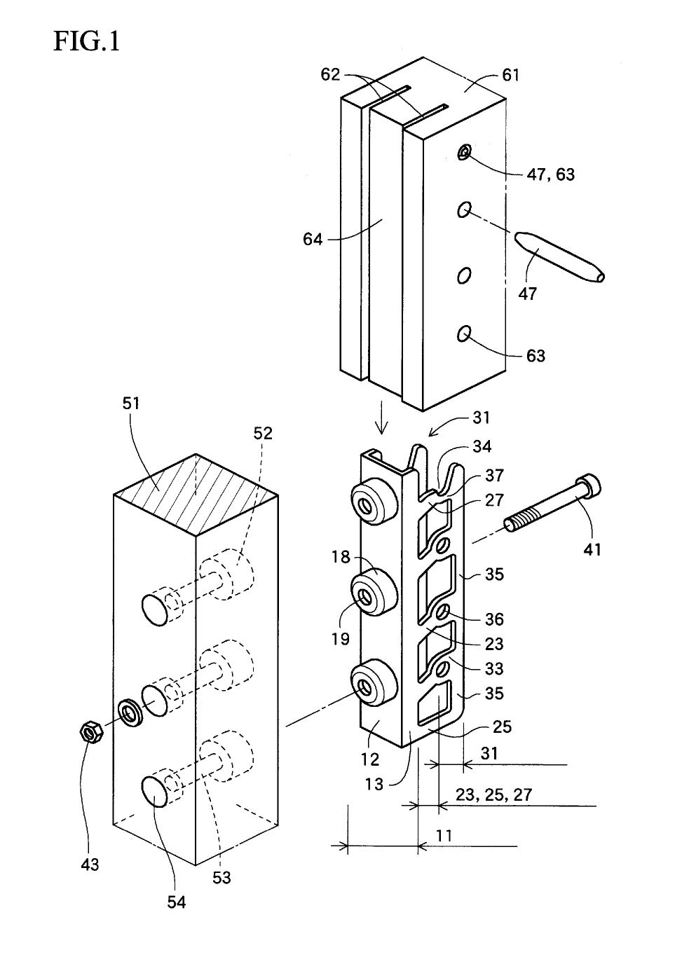

FIG. 1 shows an exemplary shape of a metal fastening fitting according to the present invention and a use state. The metal fastening fitting is used to fix the end surface of a beam to a side surface of a vertically erected pillar and construct a T-shaped fastening portion. Two members to be fastened are not limited to a pillar and a beam. In order to show the generic nature of these referents, the pillar is referred to as a support member 51 and the beam is referred to as a connecting member 61. Then, roughly classified, the metal fastening fitting comprises three elements comprising a front surface section 11, a rear edge section 31 and ramiform sections 23, 25, 27. The front surface section 11 and the rear edge section 31 are spatially separated.

The front surface section 11 is a portion for fixing the metal fastening fitting to the support member 51, and has a U-shape that can be seen from its upper side, and comprises a central front surface plate 12, front edge plates 13 situated on both sides thereof, and a projection 18 projecting from the front surface plate 12. Of these elements, the front surface plate 12 has a longitudinal planar shape, and is in surface-contact with the side surface of the support member 51. Further, the projection 18 is a portion that projects from the front surface plate 12 to form a columnar shape, and a function thereof is not different from that of conventional functions. A front hole 19 for insertion of the bolt 41 is formed at the center of the projection 18. The front edge plate 13 is a portion in which both left and right sides of the front surface plates 12 are bent in right angle, and connected to ramiform sections 23, 25, 27. In the support member 51, a receiving hole 52 in which the projection 18 is fit, and a drilled hole 53 for insertion of a bolt 41, and a counterbore 54 for receiving a nut 43 have been machined.

Rear edge sections 32 are portions for fixing the metal fastening fitting to the connecting member 61, and comprises islet portions 33, 37 formed on the end of the ramiform sections 23, 27, and a connection plate 35 connecting islet portions 33, 37 with one another. The islet portions 33, 37 are provided to form a pinhole 36 for insertion of a drift pin 47 and the pin groove 34 for receiving a drift pin 47. The connection plate 35 is provided to couple all islet portions 33, 37. On the end portion of the connecting member 61, double slits 62 for inserting the rear edge sections 31, and offset portion 64 that receives the front surface plate 12 have been machined. Further, on the side surface of the connecting member 61, a side hole 63 is machined at a position concentric to the pinhole 36 and the pin groove 34.

The ramiform sections 23, 25, 27 are portions projecting from the front edge plate 13, and having a finite width and a ramiform shape, and couple the front surface section 11 with the rear edge sections 31. The ramiform sections 23, 25, 27 comprises five ramiform sections arrayed vertically, wherein the topmost ramiform section 27 projects obliquely upward to connect to the islet portion 37 in which the pin groove 34 is formed. The lowermost ramiform section 25 projects horizontally to connect to the connection plate 35, in which there are no islet portions 33, 37. Other than the above, three ramiform sections 23 at intervals project obliquely upward to connect to substantially disk-shaped islet portions 33.

The ramiform sections 23, 25, 27 serve to transmit the load applied onto rear edge section 31 to the front surface section 11. However, the cross-sectional areas of the ramiform sections 23, 25, 27 are finite, and eventually have an inferior strength. Therefore, when an excessive load is applied onto the connecting member 61, the ramiform sections 23, 25, 27 plastically deform in the manner of bending. In this process, the ramiform sections 23, 25, 27 can absorb the energy by the load to refrain the destruction of the member as much as possible.

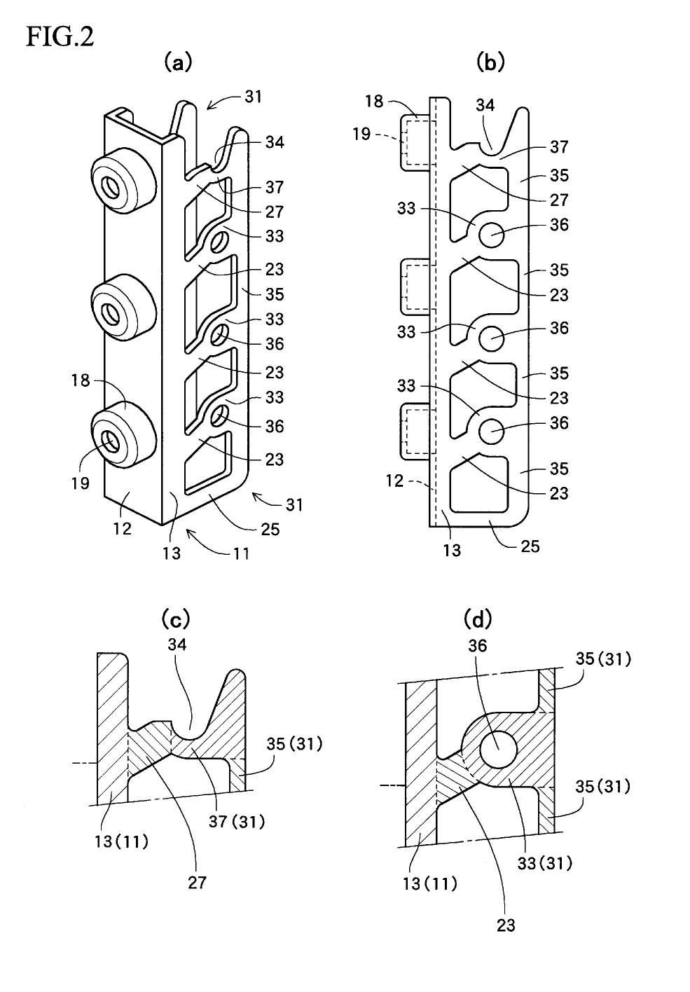

FIG. 2 shows the details of the metal fastening fitting shown in FIG. 1. The islet portion 37 at the topmost position is formed integrally with the ramiform section 27 to be paired therewith. While there is no strict boundary between both portions, the ramiform section 27 is defined as the portion closer to the front surface section 11 than the pin groove 34, and islet portion 37 is defined as the portion extending therefrom to the distal end, as shown in FIG. 2(c). Further, all islet portions 33, 37 are coupled via the connection plate 35, and the lowermost portion of the connection plate 35 couples with the front edge plate 13 via the horizontally extending ramiform section 25. Only the ramiform section 25 of the lowermost portion does not have the islet portions 33, 37. In order to prevent excessive concentration of stress, both ends of the ramiform sections 23, 25, 27 are provided with a fillet to smoothly connect to other portions.

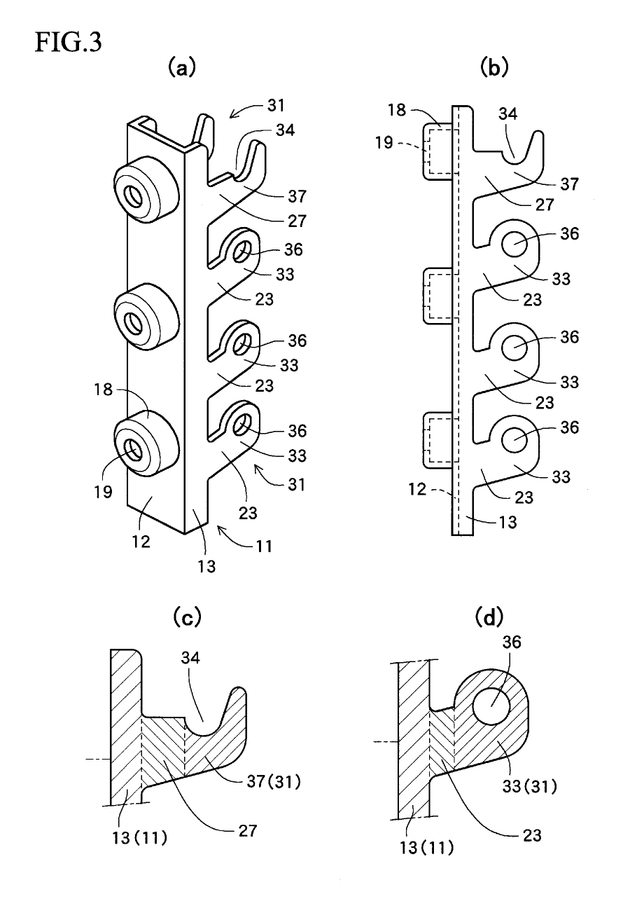

FIG. 3 shows a metal fastening fitting without using the connection plate 35. The connection plate 35 provides an effect of equalizing load applied onto the individual islet portions 33, 37. However, if plastic deformation is rather desired in an early stage, the connection plate 35 need not be used as shown in FIG. 3. In this embodiment, individual ramiform sections 23, 27 are provided with, at the ends thereof, respective one of the islet portions 33, 37, in each of which one pinhole 36 or one pin groove 34 is formed. The width of the ramiform sections 23, 27 of the drawing is approximately twice the diameter of the pinhole 36.

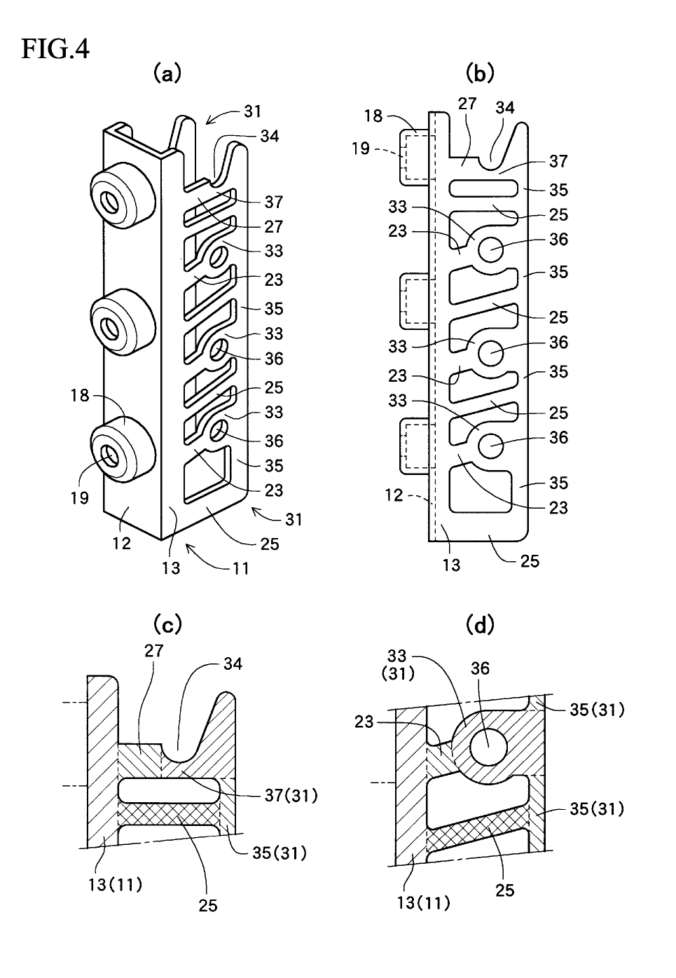

FIG. 4 shows a metal fastening fitting in which the number of ramiform sections 23, 25, 27 is increased. The ramiform sections 23, 25, 27 are essential elements to determine the capacity of proof stress of the metal fastening fitting, and when desiring relatively reduced plastic deformation against an excessive load, the number of ramiform sections 23, 25, 27 may be increased, as shown in FIG. 4. Between the vertically adjoining islet portions 33, 37, is provided a ramiform section 25 directly connecting the front edge plate 13 and the connection plate 35, so that the rigidity of the rear edge section 31 is improved. However, there is no difference from the above configurations in which the front surface section 11 and the rear edge section 31 are coupled via the ramiform sections 23, 25, 27 and, the ramiform sections 23, 25, 27 begin plastic deforming upon receiving a load exceeding a limit.

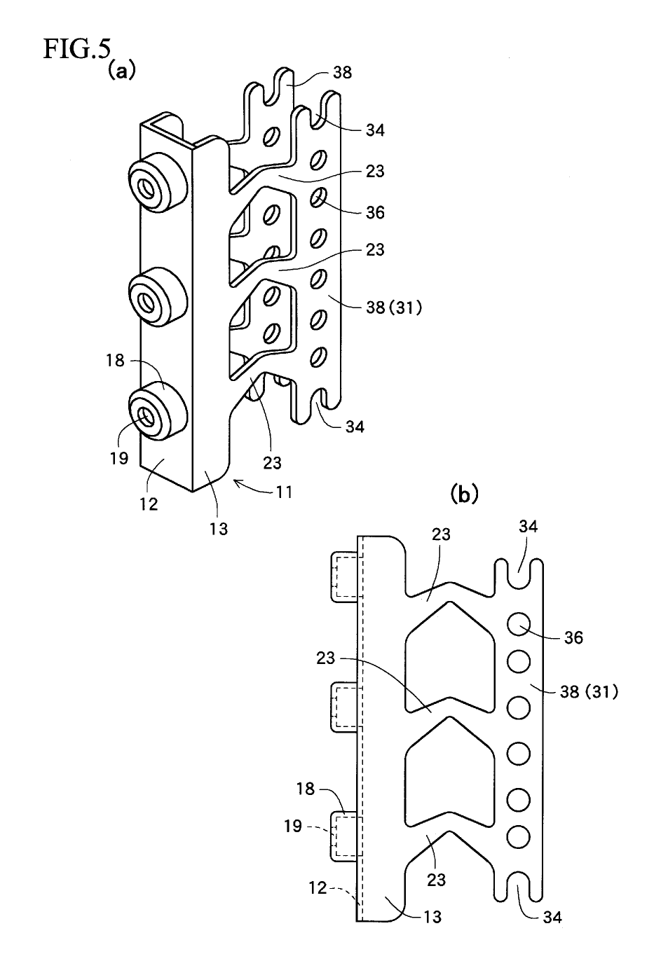

FIG. 5 shows a metal fastening fitting using a vertical plate 38 as the rear edge section 31. The vertical plate 38 is a vertically extending rectangular plate, inside which a pinhole 36 is formed and further, pin grooves 34 are formed on both upper and lower surfaces. Since the pin grooves 34 are formed on both upper and lower surfaces, the metal fastening fitting can also be used in upside down placement. Further, the ramiform sections 23 couple the front edge plate 13 with the vertical plate 38, and all three ramiform sections 23 have an inclined L shape whose center portion projects upwardly. By configuring the ramiform sections 23 to have this shape, when the horizontal load is applied onto the rear edge section 31, a bending moment is generated on the ramiform sections 23 so that plastic deformation occurs more readily.

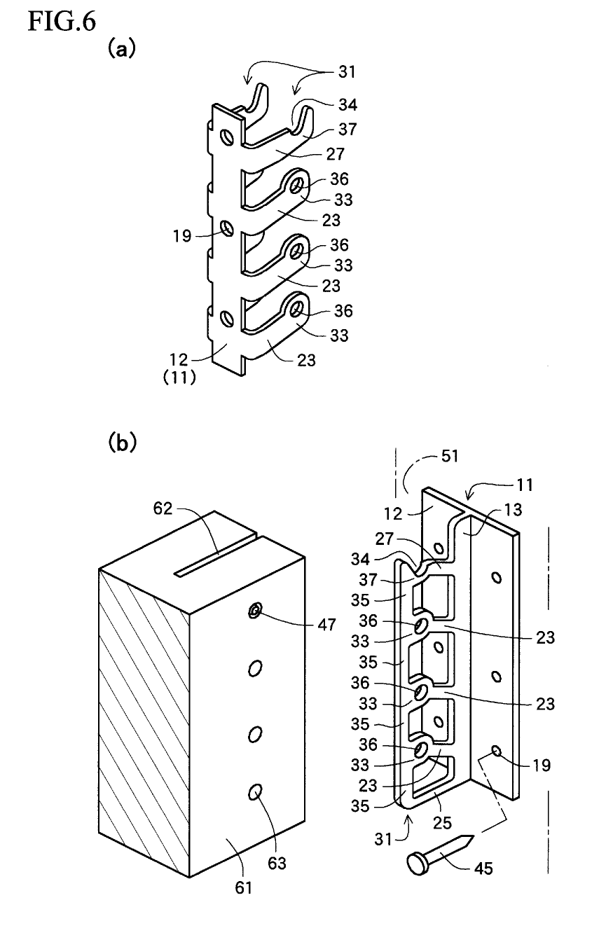

FIG. 6 shows other exemplary shapes of the metal fastening fitting. Another exemplary shape 1 as shown in FIG. 6(a) is based on the structure shown in FIG. 3, in which while islet portions 33, 37 are formed at the end of the ramiform section 23, 27, there is no connection plate 35 that couples the individual islet portions 33, 37 with one another. Further, the front surface section 11 consists only of the front surface plate 12, and the projection 18 and the front edge plate 13 are omitted. The front hole 19 is necessary, and the front hole 19 is provided in the center of the front surface plate 12. Further, the ramiform sections 23, 27 project straight from both left and right sides of the front surface plate 12 and are bent at a midpoint to be connected to the rear edge section 31. In this way, the structure of connection between the front surface section 11 and the ramiform sections 23, 27 can be changed freely as necessary.

Another exemplary shape 2 shown in FIG. 6(b) is based on the structure shown in FIG. 2. However, the rear edge section 31 is single, and T-shaped as viewed from the above. Therefore, only a single line of the slit 62 is machined on the connecting member 61. Further, the front surface section 11 comprises the rectangular front surface plate 12 and a front edge plate 13 projecting from the center thereof, and a front hole 19 is formed on the surface of the front surface plate 12. On the execution of construction work, after the side surface of the support member 51 is brought into contact with the front surface plate 12, a nail 45 is driven from the front hole 19. Instead of the nail 45, a small screw or the like may be used.

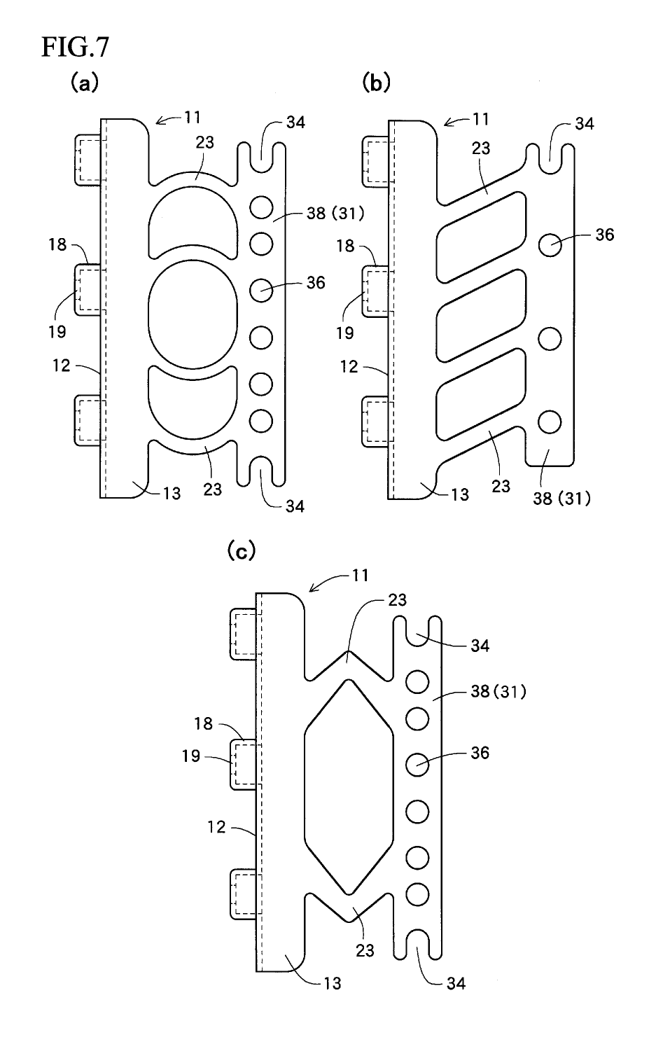

FIG. 7 also shows another exemplary shape of the metal fastening fitting. Each metal fastening fitting of this figure is based on the embodiments of FIG. 5. Although it is similar as the above in that the vertically extending vertical plate 38 is the rear edge section 31, the shape and/or other factor of the ramiform sections 23 is different therefrom. Another exemplary shape 3, as shown in FIG. 7(a), has arcuate-shaped ramiform sections 23 projecting upwardly or downwardly. By employing the arcuate shape, when horizontal load is applied onto a rear edge section 31, a bending moment is created in the ramiform sections 23 so that the plastic deformation occurs more readily. The pin groove 34 is provided on both upper and lower sides of the vertical plate 38, so that the metal fastening fitting can be used by with an upside down position. For this, the ramiform sections 23 are arranged to be line symmetric with respect to the horizontal line, and even when it is used by being turned upside down, there arises no difference in the deformation characteristics and/or the like of the ramiform section 23.

In another exemplary shape 4 shown in FIG. 7(b), a pin groove 34 is provided only on the upper side of the vertical plate 38, and using thereof in the position turned upside down is not presupposed. Therefore, all ramiform sections 23 are inclined upwardly from the front surface section 11 to the rear edge section 31. Further, another exemplary shape 5 shown in FIG. 7(c) has a pin groove 34 provided on both top and bottom surfaces of the vertical plate 38, and can be used by being turned upside down. Further, the ramiform sections 23 have an inclined L shape in which the center portion projects upwardly or downwardly. Therefore, when a load is applied onto the rear edge section 31, stress is concentrated also in the center in addition to both ends of each of the ramiform sections 23, so that the plastic deformation occurs more readily.

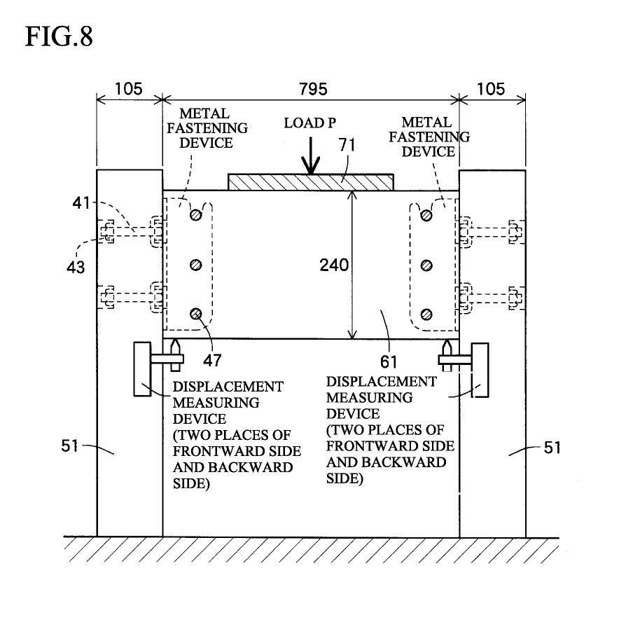

FIG. 8 is a side view showing a method of testing on evaluating strength of the metal fastening fitting. As described in the foregoing, the metal fastening fitting according to the present invention absorbs energy by the plastic deformation of the ramiform sections 23, 25, 27 when an excessive load is applied thereunto to delay the destruction of members as much as possible. In order to confirm this, a shearing test is performed by using the method shown in FIG. 8. This test is based on the method defined by The Foundation of Japan Housing and Wood Technology Center.

As shown in FIG. 8, in this test, a portal test body is used in which one beam 61 is supported by two pillars 51, 51, and a same metal fastening fitting is assembled in two fastening portions at which the pillar 51 and the beam 61 come in contact with one another in a T-shaped manner. Then, on the top surface of the beam 61, the steel pressurized plate 71 is erected and the concentrated load is applied onto the center thereof. Further, in order to measure displacement of the beam 61, displacement measuring devices are attached near the end portion of the beam 61. The displacement measuring devices, in order to suppress the effect of the crack of the lumber or the like, are attached to two places of the frontward side and the backward side of the beam 61, and an average of measurement value on four portions is determined as the amount of displacement.

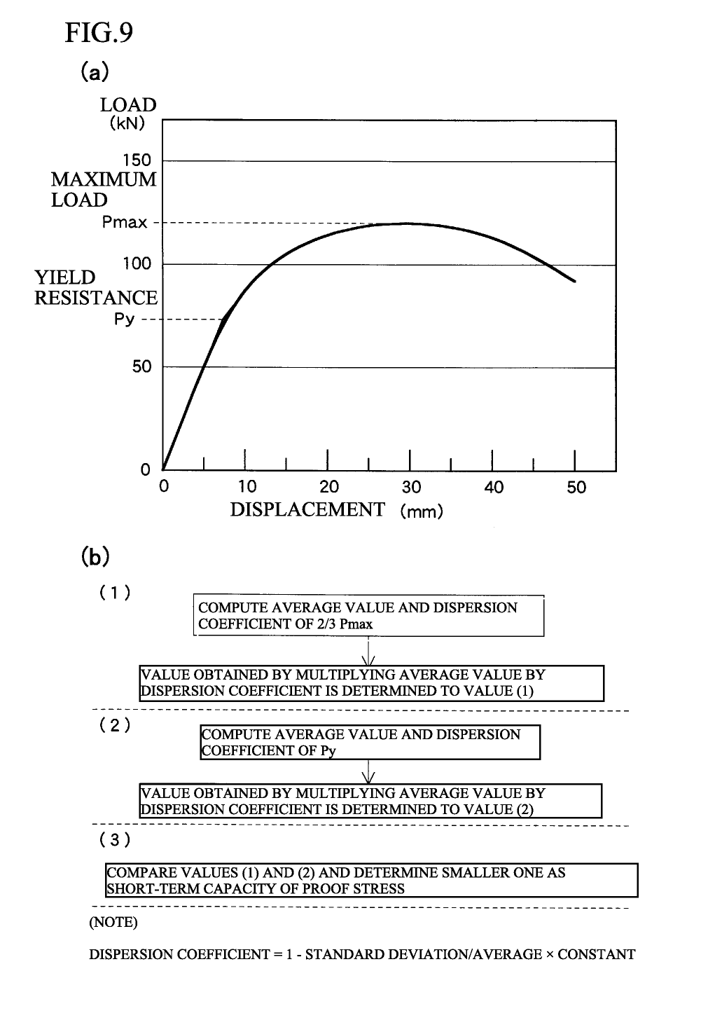

When the test is implemented on the method shown in FIG. 8, a displacement-load graph may be drawn as shown in FIG. 9(a), and based on this, a short-term capacity of proof stress of the metal fastening fitting (against the shearing load) may be computed. Short-term capacity of proof stress refers to an upper limit of load under which the structure can withstand without undergoing any destruction. The wording “short-term” is used because long-term factors, such as corrosion, are out of consideration. The horizontal axis of the graph indicates displacement, whose value is an average among four points. The vertical axis indicates a load applied onto the center of the beam 61, in which the maximum load (Pmax) is at the highest position in the graph. Further, the yield resistance (Py) is a value geometrically computed from the shape of the curve of the graph and corresponds to the yield point of metallic materials.

Lumber, including glued laminated lumber, is naturally-derived material, and inevitably has individual differences in strength due to various factors. Therefore, upon implementing the test, at least six test bodies are used and graphs are prepared therefor individually, and maximum load and yield resistance is determined each time.

The short-term capacity of proof stress is computed by the method shown in FIG. 9(b). Specifically, an average of values obtained by multiplying Pmax by ⅔ and a dispersion coefficient thereof are computed. Further, an average value of Py and a dispersion coefficient thereof are computed. Then, for both values (Pmax×⅔ and Py), a value obtained by multiplying the average value by the dispersion coefficient is computed, and the smaller is determined to be the short-term capacity of proof stress. The dispersion coefficient is computed based on the formula indicated in the bottommost portion of FIG. 9, whose value becomes equal to or less than one. Therefore, in order to improve the short-term capacity of proof stress, the standard deviation of Pmax and Py is made small so that the dispersion coefficient becomes close to one to enhance the stability.

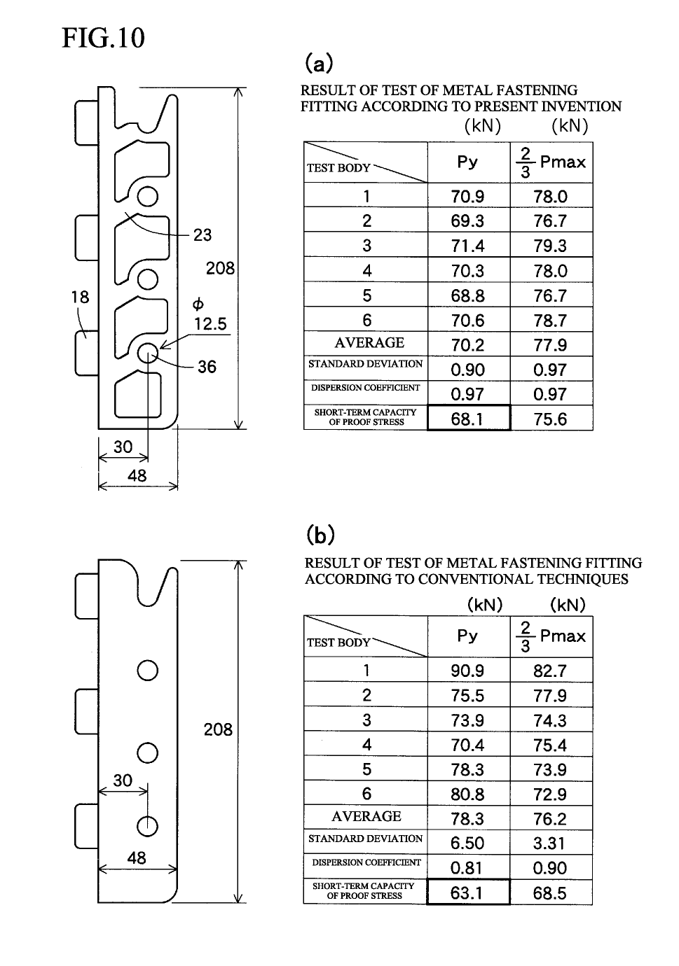

FIG. 10 shows the result of the test obtained by the method shown in FIG. 8. The test is implemented on a conventional metal fastening fitting, in addition to the metal fastening fitting shown in FIG. 2, for comparison. Both metal fastening fittings have a similar arrangement and shape of projections and pinholes. The average value of the yield resistance (Py) of the metal fastening fitting according to the present invention is less than that of conventional ones. This means that by providing ramiform sections with plastic deformation at an early stage, a delay in a destruction of the member will result. The metal fastening fitting including the ramiform section is trimmed from a steel plate to have a predetermined shape, involving substantially no individual differences in features, such as, those of plastic deformation. Therefore, the metal fastening fitting according to the present invention has less difference between the graphs except for the final stage, and dispersion coefficients of both yield resistance and the maximum load become close to one. As a result, in the matter according to the present invention, the short-term capacity of proof stress is improved as compared to conventional ones, as indicated by the bold box in the result of the test.

By creating a graph for a displacement-load based on the result of the test of the metal fastening fitting according to the present invention, it is find that an area bounded by the graph and x-axis (an integrated value of the result of the test) from the start of test to the end was larger than that of the conventional techniques. That is, experimental evidence indicates that more energy is absorbed by plastic deformation of the metal fastening fitting.

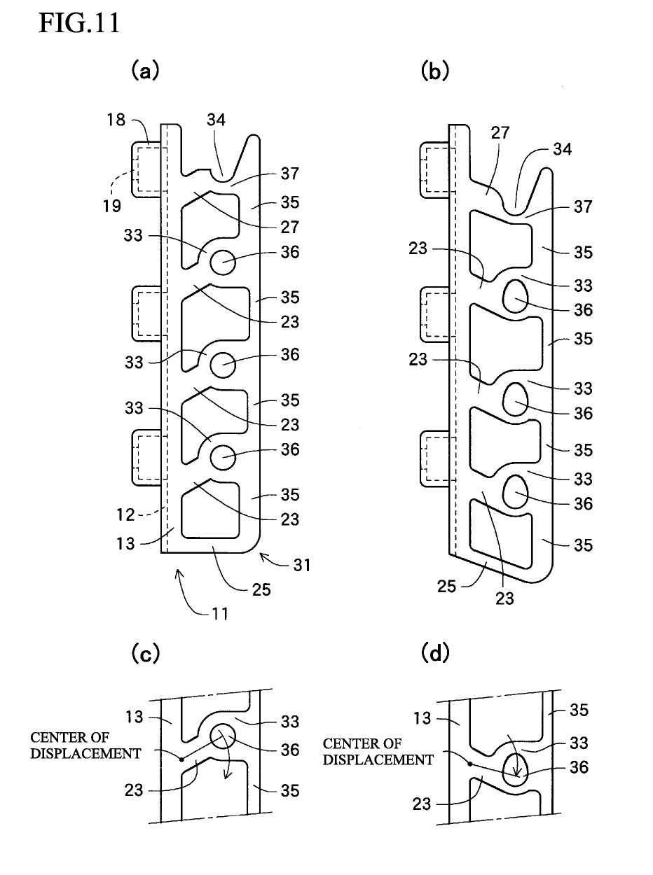

FIG. 11 shows a state in which an excessive load is applied onto the metal fastening fitting shown in FIG. 2 to cause plastic deformation. Ramiform sections 23, 27 before the deformation are, as shown in FIG. 11(a) and (c), inclined upwardly from the front surface section 11 to the rear edge section 31. However, when an excessive vertical load is applied onto the rear edge section 31, the ramiform sections 23, 25, 27 deform in a manner of rotation about the connection portion between the front edge plate 13 and the ramiform sections 23, 25, 27, so that the angle of the ramiform sections 23, 25, 27 changes in a downward direction as shown in FIG. 11(b) and (d). Further, the pinhole 36 and pin groove 34 are deformed in the manner of being pushed downward, so that the shape of the pinhole 36 becomes oblong and the diameter thereof increases.

In this way, by forming the ramiform sections 23, 27 to be angled upwardly, the ramiform sections 23, 27 undergo plastic deformation before and after undergoing the state of being oriented in the horizontal direction. Therefore, the distance between the front surface section 11 and the rear edge section 31 become large, permitting an increase of the bending moment applied to ramiform sections 23, 27, making it easy for the plastic deformation to occur. Further, when the ramiform sections 23, 27 are plastically deformed from upward to downward angles, the distance between the front surface section 11 and the rear edge section 31 do not change significantly. Therefore, the rear edge section 31 moves in substantially a vertically downward direction and, the beam 61 fixed to the rear edge section 31 depresses as well naturally. If the ramiform sections 23, 27 were angled downward from the beginning, the rear edge section 31 would come close to the front surface section 11 along with the deformation, in which smooth depression of the beam 61 would be difficult to achieve.

### DESCRIPTION OF REFERENCE NUMERALS

11 Front surface section
12 Front surface plate
13 Front edge plate
14 Side surface plate
18 Projection
19 Front hole
23 Ramiform sections
25 Ramiform section (directly connecting the front edge plate and the connection plate)
27 Ramiform section (directly connecting the front edge plate and an islet portion in which the pin groove is formed)
31 Rear edge section
33 Islet portion (in which a pinhole is formed)
34 Pin groove
35 Connection plate
36 Pinhole
37 Islet portion (in which a pin groove is formed)
38 Vertical plate
41 Bolt
43 Nut
45 Nail
47 Drift pin
51 Support member (pillar or the like)
52 Receiving hole
53 Drilled hole
54 Counterbore
61 Connecting member (beam or the like)
62 Slit
63 Side hole
64 Offset portion
71 Pressurized plate

1. A metal fastening fitting for fastening an end surface of a connecting member (61) to a side surface of a support member (51) in a T-shaped manner, comprising:
a front surface section (11) being in contact with the side surface of the support member (51) and fixed to the support member (51) by a bolt (41), a nail (45) or the like; and a rear edge section (31) inserted into a slit (62) machined on an end portion of the connecting member (61) and fixed to the connecting member (61) by a bar such as a drift pin (47), wherein
a front hole (19) for insertion of the bolt (41), the nail (45) or the like is provided on the front surface section (11), and a pinhole (36) for insertion of the drift pin (47) or the like, or a pin groove (34) for receiving the drift pin (47) or the like is provided on the rear edge section (31), and
the front surface section (11) and the rear edge section (31) are coupled via a plurality of ramiform sections (23, 25, 27).

2. The metal fastening fitting according to claim 1, wherein the rear edge section (31) is an islet portion (33, 37) provided on an end of each of ramiform sections (23, 27), wherein each of islet portions (33, 37) comprises the pinhole (36) or the pin groove (34).

3. The metal fastening fitting according to claim 2, wherein all of the islet portions (33, 37) are coupled by a connection plate (35).

4. The metal fastening fitting according to claim 1, wherein the rear edge section (31) is a vertically extending strip-shaped vertical plate (38), and the pinhole (36) and the pin groove (34) are provided in the vertical plate (38).

5. The metal fastening fitting according to claim 1, wherein the ramiform sections (23, 27) are inclined upwardly from the front surface section (11) toward the rear edge section (31).

6. The metal fastening fitting according to claim 1, wherein a center portion of the ramiform section (23) is configured to project either upwardly or downwardly, and has an inclined L shape or an arcuate shape.

7. The metal fastening fitting according to claim 2, wherein the ramiform sections (23, 27) are inclined upwardly from the front surface section (11) toward the rear edge section (31).

8. The metal fastening fitting according to claim 2, wherein a center portion of the ramiform section (23) is configured to project either upwardly or downwardly, and has an inclined L shape or an arcuate shape.

9. The metal fastening fitting according to claim 3, wherein the ramiform sections (23, 27) are inclined upwardly from the front surface section (11) toward the rear edge section (31).

10. The metal fastening fitting according to claim 3, wherein a center portion of the ramiform section (23) is configured to project either upwardly or downwardly, and has an inclined L shape or an arcuate shape.

11. The metal fastening fitting according to claim 4, wherein the ramiform sections (23, 27) are inclined upwardly from the front surface section (11) toward the rear edge section (31).

12. The metal fastening fitting according to claim 4, wherein a center portion of the ramiform section (23) is configured to project either upwardly or downwardly, and has an inclined L shape or an arcuate shape.
